(19) United States
(12) Patent Application Publication
(10) Pub. No.: US 2018/0173966 A1
(43) Pub. Date: Jun. 21, 2018

(54) METHOD AND DEVICE FOR TARGET DETECTION

(71) Applicant: Sengled Co., Ltd., Shanghai (CN)

(72) Inventors: Peipei SHI, Shanghai (CN); Jinxiang SHEN, Shanghai (CN)

(21) Appl. No.: 15/739,048

(22) PCT Filed: Dec. 15, 2016
(86) PCT No.: PCT/CN2016/110068

§ 371 Date: Dec. 21, 2017

(30) Foreign Application Priority Data
Dec. 29, 2015 (CN) 201511018624.7

(51) Int. Cl. G06K 9/00; G06K 9/62

(52) U.S. Cl. CPC G06K 9/00771; G06K 9/6202

(57) ABSTRACT

Method and device for target detection are provided. An exemplary method includes performing a target detection on a currently-to-be-detected video frame image to determine at least one target; based on an area occupied by each of the at least one target in the currently-to-be-detected video frame image and a background marker image, determining false targets present in the at least one target, the background marker image being configured to indicate an area occupied by a background of the at least one target; and reporting non-false targets other than the false targets in the at least one target.

### CROSS-REFERENCES TO RELATED APPLICATIONS

This application is a continuation application of PCT Patent Application No. PCT/CN2016/110068, filed on Dec. 15, 2016, which claims the priority of Chinese Patent Application No. 201511018624.7, filed on Dec. 29, 2015, the entire content of which is incorporated herein by reference.

### FIELD OF THE DISCLOSURE

The present disclosure generally relates to the field of video surveillance technologies and, more particularly, relates to a method and a device for target detection.

### BACKGROUND

Target detection is a key technology and an important part of a video surveillance system.

Conventionally, detection models are often used for target detection in surveillance videos. Sometimes, the features of certain background objects can be very similar to the features of the target to-be-detected. As a result, when using detection models, a background object, having a feature similar to the target, can be mistakenly reported as the target. Currently, the images of the false targets may be used as negative samples to retrain the detection models, so as to eliminate report of false targets.

The disclosed device and method are directed to solve one or more problems set forth above and other problems in the art.

### BRIEF SUMMARY OF THE DISCLOSURE

One aspect or embodiment of the present disclosure includes a method for a target detection by performing a target detection on a currently-to-be-detected video frame image to determine at least one target; based on an area occupied by each of the at least one target in the currently-to-be-detected video frame image and a background marker image, determining false targets present in the at least one target, the background marker image being configured to indicate an area occupied by a background of the at least one target; and reporting non-false targets other than the false targets in the at least one target.

Optionally, a height of the background marker image is same as a height of the currently-to-be-detected video frame image; a width of the background marker image is same as a width of the currently-to-be-detected video frame image; a resolution of the background marker image is same as a resolution of the currently-to-be-detected video frame image; and a pixel value of a pixel in the background marker image is used to indicate a probability of an area corresponding to each pixel being a part of the background.

Optionally, the step of determining false targets present in the at least one target includes: for each of the at least one target, based on pixel values of pixels in a first region of the background marker image, determining if each target is a false target, the first region of the background marker image corresponding to an area occupied by the target in the currently-to-be-detected video frame image.

Optionally, the step of determining if each target is a false target based on pixel values of pixels in a first region includes: determining a maximum pixel value in the first region and a number of pixels each having a pixel value greater than a first preset value; and if the maximum pixel value is greater than or equal to a second preset value and the number of pixels each having the pixel value greater than the first preset value is greater than or equal to a preset number, determining each target is a false target, the first preset value being less than the second preset value.

Optionally, after determining if each target is a false target, the method further includes: updating the pixel values of the pixels in the first region of the background marker image.

Optionally, updating the pixel values of the pixels in the first region further includes increasing the pixel value of a pixel in the first region by a preset value, the preset value being greater than 0.

Optionally, the method further includes updating a pixel value of a pixel in a second region in the background marker image, the second region corresponding to an area occupied by each of the N targets in a previous video frame image. N is an integer and the N targets are targets determined through a target detection on the previous video frame image.

Optionally, a time interval between the previous video frame image and the currently-to-be-detected video frame image includes a preset time interval.

Optionally, updating the pixel values of pixels in the second region further includes decreasing the pixel value of a pixel in the first region by the preset value.

Optionally, the at least one target includes a target set.

Optionally, the method further includes: determining a maximum pixel value and a number of pixels having a pixel value greater than a first preset value for a target in the first region; and if the maximum pixel value is greater than or equal to a second preset value, and the number of pixels having a pixel value greater than the first preset value is greater than a preset number, determining the target to be a false target.

Optionally, the method further includes: based on the target set, updating a target queue detected in a preset time interval and the background marker image, wherein the target queue includes a queue of target sets detected in the preset time interval.

Another aspect or embodiment of the present disclosure includes a device for a target detection. The device includes a detection module, configured to perform a target detection on a currently-to-be-detected video frame image to determine at least one target; a false target determining module, configured to determine false targets present in the at least one target based on area occupied by each of the at least one target in the currently-to-be-detected video frame image and a background marker image, the background marker image indicating an area occupied by a background of the at least one target; and a reporting module, configured to report non-false targets other than the false targets in the at least one target.

Optionally, a height of the background marker image is same as a height of the currently-to-be-detected video frame image; a width of the background marker image is same as a width of the currently-to-be-detected video frame image; a resolution of the background marker image is same as a resolution of the currently-to-be-detected video frame image; and a pixel value of a pixel in the background marker image is used to indicate a probability of an area corresponding to each pixel being a part of the background.

Optionally, determining false targets present in the at least one target includes: for each of the at least one target, based on pixel values of pixels in a first region of the target, determining if each target is a false target, the first region in the background marker image corresponding to an area occupied by the target in the currently-to-be-detected video frame image.

Optionally, the false target determining module determines a maximum pixel value of pixels in the first region and a number of pixels having a pixel value greater than the first preset value, in the background marker image; and if the maximum pixel value is greater than or equal to a second preset value and the number of pixels each having the pixel value greater than the first preset value is greater than or equal to a preset number, the false target determining module determines each target is a false target.

Optionally, the first preset value is less than the second preset value.

Optionally, the device further includes an updating module, configured to update pixel values of pixels in the first regions.

Optionally, the updating module is configured to update pixel values of pixels in a second region in the background marker image, the second region corresponding to an area occupied by each of N targets in a previous video frame image, N being an integer, the N targets being targets determined through a target detection on the previous video frame image, the time interval between the previous video frame image and the currently-to-be-detected video frame image being a preset time interval.

Optionally, the at least one target includes one or more target sets.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of an exemplary method for target detection consistent with various disclosed embodiments of the present disclosure;

FIG. 2 illustrates a flow chart of another exemplary method for target detection consistent with various disclosed embodiments of the present disclosure;

FIG. 3 illustrates exemplary false targets consistent with various disclosed embodiments of the present disclosure;

FIG. 4 illustrates a flow chart of another exemplary process for target detection consistent with various disclosed embodiments of the present disclosure;

FIG. 5 illustrates a flow chart of another exemplary method for target detection consistent with various disclosed embodiments of the present disclosure;

FIG. 6 illustrates an exemplary target detection device consistent with various disclosed embodiments of the present disclosure;

FIG. 7 illustrates another exemplary target detection device consistent with various disclosed embodiments of the present disclosure; and

FIG. 8 illustrates a block diagram of controller used in various disclosed embodiments of the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

The present disclosure provides a method and a device for target detection, to avoid retraining detection models used in conventional technology.

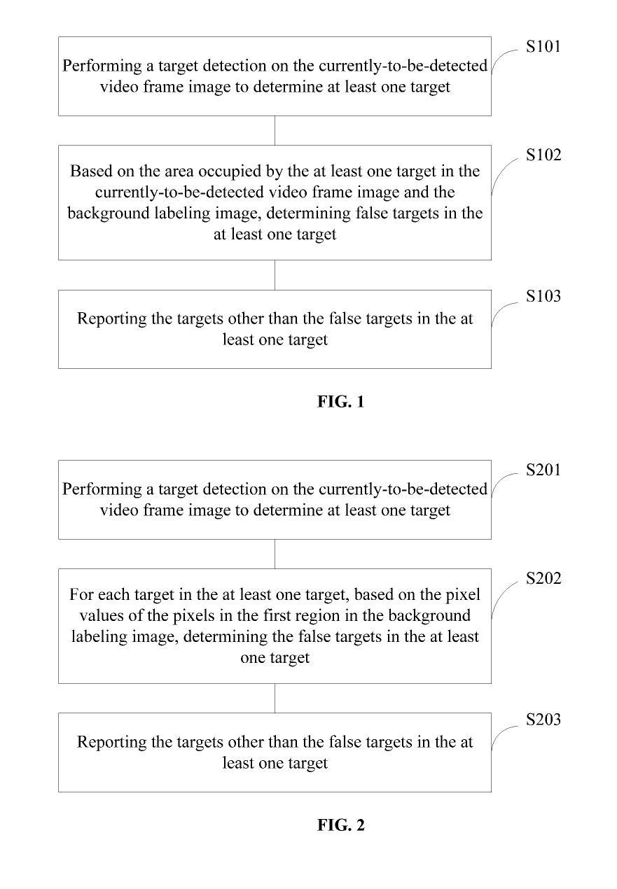

One aspect of the present disclosure provides a method for target detection. As shown in FIG. 1, the method may include steps S101-S103.

In step S101, a target detection may be performed on the currently-to-be-detected video frame image to determine at least one target.

In step S102, based on the area occupied by the at least one target in the currently-to-be-detected video frame image and the background marker image, false targets may be determined in the at least one target. The background marker image may be used to indicate the area occupied by the background, e.g., the surrounding area/background of the at least one target.

In step S103, the targets other than the false targets, or “non-false targets”, in the at least one target may be reported.

In one embodiment, based on the area of each one of the at least one target in the currently-to-be-detected video frame image, and the background marker image indicating the area occupied by the background of the at least one target, false targets, in the at least one target, may be determined. The non-false targets other than the false targets in the at least one target may be reported. Thus, false targets in the at least one target may be eliminated based on the background marker image. Compared to the technique that uses images of false targets as negative samples to retrain the detection models and eliminate false targets, detection models may not need to be retrained according to the disclosed method.

FIG. 2 illustrates another exemplary method of the disclosed target detection method. As shown in FIG. 2, the method may include steps S201-S203.

In step S201, a target detection may be performed on the currently-to-be-detected video frame image to determine at least one target.

In some embodiments, step S201 may include applying detection models to performing a target detection on the currently-to-be-detected video frame image.

In step S202, for each target in the at least one target, based on the pixel values of the pixels in the first region in the background marker image, false targets in the at least one target may be determined. The first region of a target may correspond to the area occupied by a target in the currently-to-be-detected video frame image.

The height of the background marker image may be the same as the height of the currently-to-be-detected video frame image, and the width of the background marker image may be the same as the width of the currently-to-be-detected video frame image. The resolution of the background marker image may be the same as the resolution of the currently-to-be-detected video frame image. The pixel value of each pixel in the background marker image may indicate the probability of the area corresponding to the pixel being a part of the background.

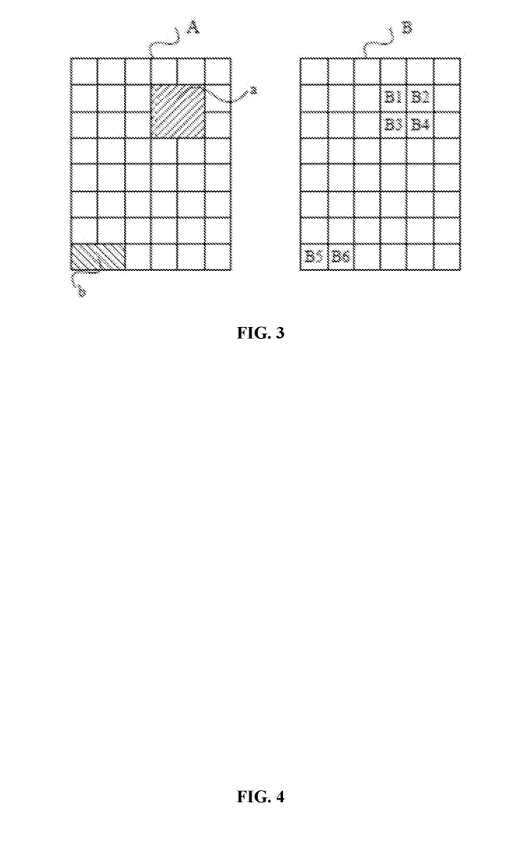

As shown in FIG. 3, a target detection may be performed on the currently-to-be-detected video frame image A. Targets a and b may be determined. As shown in FIG. 3, the area occupied by target a in the video frame image may be filled with left slashes, and the area occupied by target b in the video frame image may be filled with right slashes. The pixel values of pixels B1, B2, B3, and B4 in the background marker image B may be used to determine if target a is a false target. The pixel values of pixels B5 and B6 in the background marker image B may be used to determine if target b is a false target.

In some embodiments, a greater pixel value of a pixel in the background marker image may indicate a higher probability of the pixel being a part of the background. In some other embodiments, a smaller pixel value of a pixel in the background marker image may indicate a lower probability of the pixel being a part of the background.

In step S203, the non-false targets other than the false targets in the at least one target may be reported.

In some embodiments, after step S202, the method may further include updating the pixel values of each pixel in the first regions in the background marker image.

In some embodiments, after step S202, the method may further include updating the pixel values of each pixel in the second regions in the background marker image. A second region may correspond to the area occupied by each one of the N targets in the previous video frame image.

N may be an integer. The N targets may be targets determined when performing a target detection on the previous video frame image. The time interval between the previous video frame image and the currently-to-be-detected video frame image may be a preset time interval.

In one embodiment, based on the pixel value of each pixel in a first region in the background marker image, false targets may be determined among each target, of the at least one target. The pixel value of each pixel in the background marker image may indicate the probability of the pixel being a part of the background. Further, non-false targets other than the false targets, in the at least one target, may be reported, so that false targets in the at least one target may be eliminated based on the background marker image. Compared to the technique that uses false images as negative samples to retrain the detection models and eliminate false targets, detection models may not need to be retrained according to the disclosed method. Accordingly, the cost of post-maintenance of the detection models and instability of the detection models may be reduced.

FIG. 4 illustrates another exemplary flow chart of the target detection method. As shown in FIG. 4, the method may include steps S401-S403.

In step S401, target detection may be performed on the currently-to-be-detected video frame image to determine at least one target. Step S401 and step S201 may be similar. Details of step S401 are not repeated herein.

In step S402, for each target in the at least one target, a maximum pixel value max in the first region in the background marker image and a number num of pixels having a pixel value greater than a first preset value may be determined. If the maximum pixel value max is greater than or equal to a second preset value and the number num is greater than or equal to a preset number, the target may be a false target.

The first preset value may be smaller than the second preset value. The first region may correspond to the area occupied by each target in the currently-to-be-detected video frame image.

The height of the background marker image may be the same as the height of the currently-to-be-detected video frame image, and the width of the background marker image may be the same as the width of the currently-to-be-detected video frame image. The resolution of the background marker image may be the same as the resolution of the currently-to-be-detected video frame image. The pixel value of each pixel in the background marker image may indicate the probability of the area corresponding to the pixel being a part of the background.

In some embodiments, the first preset value, the second preset value, and the preset number may be determined according to different applications and/or different backgrounds. For example, the first preset value or first preset threshold value T₁=n*ratio₂, the second preset value or second preset threshold value Tₕ=n*ratio₁, where n represents the number of video frame images included in the preset time interval, 0.1<ratio₁<0.9, 0.1<ratio₂<0.9, ratio₂ being smaller than ratio₁. Preset number N=ratio₃*Area, where 0.1<ratio₃<0.9, Area being the total number of pixels in the area occupied by each target. The values of ratio₁, ratio₂, and ratio₃ may be determined by the user.

For example, referring to FIG. 3, assuming, for target b, the pixel value of pixel B1 is 10, the pixel value of pixel B2 is 30, the pixel value of pixel B3 is 10, and the pixel value of pixel B4 is 20. The first preset value may be 15, the second preset value may be 25, and the preset number may be 3. Accordingly, the maximum pixel value, in the area in the background marker image that corresponds to the area occupied by target b in the video frame image, may be 30. The number of pixels, having a pixel value greater than 15, may be 3. Because the maximum pixel value 30 is greater than the second preset value 25, and the number of pixels having a pixel value greater than 15 is 3, being equal to the preset number, target b may be a false target.

In some embodiments, step S402 may further include determining the target to be a normal target (i.e., not being a false target), if pₘₐₓ is smaller than the second preset value or num is smaller than the preset number.

In step S403, the non-false targets other than the false targets in the at least one target may be reported.

In some embodiments, after step S402, the method may further include increasing the pixel value of each pixel in a first region in the background marker image by a preset value, where the preset value is greater than 0.

For example, referring to FIG. 3, assuming the preset value is 1. The pixel value of pixel B1 may be increased/updated by 1 (e.g., if the pixel value of pixel B1 is 10, the pixel value of pixel B1 after the update may by 11), the pixel value of pixel B2 may be increased by 1, the pixel value of pixel B3 may be increased by 1, the pixel value of pixel B4 may be increased by 1, the pixel value of pixel B5 may be increased by 1, and the pixel value of pixel B6 may be increased by 1.

In some embodiments, after step S402, the method may further include decreasing the pixel value of each pixel in a second region in the background marker image by the preset value. A second region may correspond to the area occupied by each one of the N targets in the previous video frame image. The N targets may be targets determined when performing a target detection on the previous video frame image. The time interval between the previous video frame image and the currently-to-be-detected video frame image may be the preset time interval.

In another example, referring to FIG. 3, assuming the preset value is 1, a target determined through a target detection on the previous frame image may be target b. Thus, the pixel value of pixel B5 may be decreased by 1, and the pixel value of pixel B6 may be decreased by 1.

In one embodiment, for each one of the at least one target, the maximum pixel value and the number of pixels, having a pixel value greater than the first preset value, in a first region in the background labeling mage, may be determined. If the maximum pixel value is greater than or equal to the second preset value and the number of pixels having a pixel value greater than the first preset value in a first region is greater than or equal to the preset number, the target may be determined to be a false target. Thus, false targets may be determined among each target based on the pixel values of pixels in the first regions in the background marker image.

For illustrative purposes, in the embodiment exemplified in FIG. 4, a greater pixel value of a pixel may indicate a higher probability the pixel being a part of the background. Based on the pixel values of pixels, in the background marker image, corresponding to the areas occupied by the targets in the currently-to-be-detected video frame image, false targets may be determined among each target.

In an embodiment exemplified in FIG. 2, a smaller pixel value of a pixel may indicate a higher probability the pixel being a part of the background. The specific steps to implement the embodiment shown in FIG. 2 may include an opposite determining condition compared to the embodiment shown in FIG. 4. The difference between the embodiments shown in FIG. 2 and FIG. 4 may mainly include the determining condition and the updates of pixel values. For example, the operation to determine the false targets and to update the pixel values may reflect that a smaller pixel value has a higher probability to be the background. Accordingly, the determining condition and the updates of the pixel values may be opposite to the embodiment shown in FIG. 4 and details are not repeated herein.

FIG. 5 illustrates another exemplary flow chart of the disclosed target detection method. As shown in FIG. 5, the method may include step S501-S503.

In step S501, performing a target detection on the currently-to-be-detected video frame image to determine a target set oᵢ.

In one embodiment, oᵢ may be recorded as oᵢ={rect₁, . . . , rectₘ}, where m may be an integer greater than or equal to 0, m may represent the number of targets obtained after performing the target detection on the currently-to-be-detected video frame image, and rectᵢ (i=1, 2, . . . , m) may represent the area occupied by the i^{th} target.

When m is equal to 0, no target detection is performed on the currently-to-be-detected frame image and no target has been determined. Accordingly, the target set oᵢ may be empty.

In step S502, for each target in the target set oᵢ, the maximum pixel value and the number of pixels having a pixel value greater than the first preset value, in the first region in the background marker image, may be determined. If the first pixel value is greater than or equal to the second preset value, and the number of pixels having a pixel value greater than the first preset value is greater than the preset number, the pixel may be determined to be a false target.

The first region may correspond to the area occupied by a target in the currently-to-be-detected video frame image, and the target may be in the target set oᵢ.

Step S502 may be similar to step S202, and details of step S502 are not repeated herein.

Before step S502, the method may further include determining if the target set oᵢ is empty. If the target set oᵢ is determined to be empty, the method may proceed to step S503. If the target set oᵢ is determined to be not empty, the method may proceed to step S502. That is, when the target set oᵢ is empty, step S503 may also be executed to update the target queue and the background marker image, such that the target queue and the background marker image may reflect data related to the most recent preset time interval.

In step S503, based on the target set oᵢ, the target queue R={oᵢ₋ₖ, . . . , oᵢ₋₂, oᵢ₋₁} detected in the preset time interval Δt and the background marker image may be updated.

k may represent the number of video frame images in the preset time interval; oᵢ₋₁ may represent the target set determined when performing a target detection on the video frame image immediately before the currently-to-be-detected video frame image, . . . , oᵢ₋ₖ may represent the target set determined when performing a target detection on the video frame image that is preset time interval before the currently-to-be-detected video frame image.

In some embodiments, in step S503, updating the target queue detected in the preset time interval Δt and the background marker image based on the target set oᵢ may include placing the target set oᵢ in the tail of the target queue and removing target set oᵢ₋ₖ from the target queue. Accordingly, the updated target queue may be R={oᵢ₋ₖ₋₁, . . . , oᵢ₋₁, oᵢ}.

Accordingly, in step S503, updating the background marker image may include increasing the pixel value of each pixel in the first regions in the background marker image by 1, and decreasing the pixel value of each pixel in the second regions in the background marker image by 1. The second regions may correspond to the area occupied by the targets in the previous video frame image. The targets may be in the target set oᵢ₋ₖ.

The pixel value of each pixel in the background marker image may correspond to the target sets in the target queue. In a certain time period, i.e., a preset time interval, the targets may be moving, and the objects in the background may be still. Thus, based on the result of target detection, the pixel values of the pixels in the background marker image may be increased or decreased such that the background marker image may reflect the area occupied by the background through the pixel values.

When performing target detection on the initial video frame image, the target queue and the background marker image may be initialized. For example, the target queue may be zeroed/emptied, and the values of the pixels in the background marker image may be set to zero. After performing target detection on the video frame images in the initial/first preset time interval, the target queue may be updated, and oᵢ₋ₖ may not need to be removed from the target queue. After performing target detection on the video frame images in the initial/first preset time interval and updating the background marker image, the pixel value of the pixels in the background marker image, e.g., region B of FIG. 3 may not need to be increased or decreased by 1.

In one embodiment, based on the target oᵢ, target queue R={oᵢ₋ₖ| . . . , oᵢ₋₂, oᵢ₋₁} detected in the preset time interval Δt and background marker image may be updated. Accordingly, the background marker image may reflect the area occupied by the background.

Another aspect of the present disclosure provides a device for target detection.

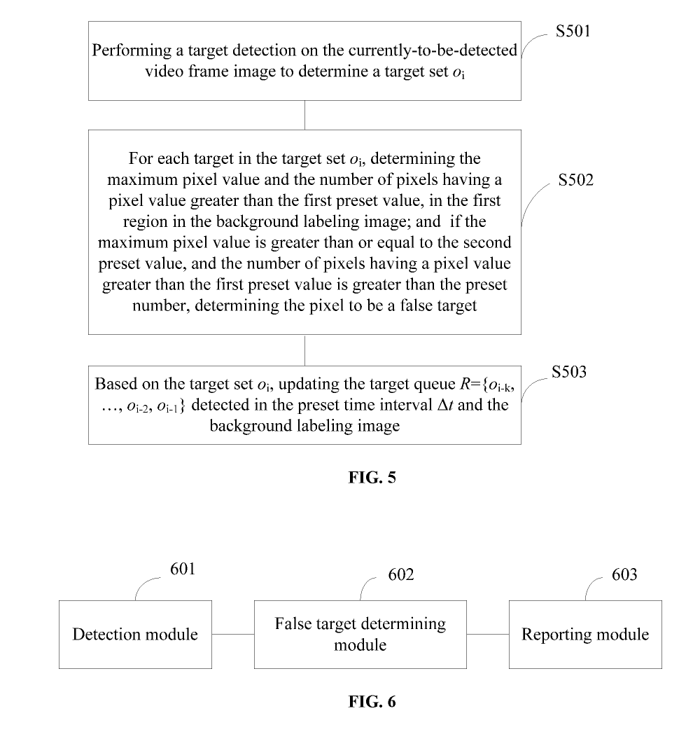

FIG. 6 illustrates an exemplary structure of the disclosed device. As shown in FIG. 6, the device may include a detection module 601, a false target determining module 602, and a reporting module 603. The detection module 601 may perform a target detection on the currently-to-be-detected video frame image to determine at least one target. The false target determining module 602 may determine false targets in the at least one target based on the area occupied by the at least one target in the currently-to-be-detected video frame image and background marker image. The background marker image may indicate the area occupied by the background. The reporting module 603 may report the targets, in the at least one target, other than the false targets.

The disclosed device for target detection may be used to execute the technical solution shown in FIG. 1. The principles and technical effects of the disclosed device may be referred to previous description and are not repeated herein.

In some embodiments, based on the disclosed device for target detection, the height of the background marker image may be the same as the height of the currently-to-be-detected video frame image, and the width of the background marker image may be the same as the width of the currently-to-be-detected video frame image. The resolution of the background marker image may be the same as the resolution of the currently-to-be-detected video frame image. The pixel value of each pixel in the background marker image may indicate the probability of the area corresponding to the pixel being a part of the background.

The false target determining module 602 may determine if one of the at least one target is a false target, based on the pixel values of the pixels in the first region. The first region may correspond to the area occupied by the target in the currently-to-be-detected video frame image.

In some embodiments, the false target determining module 602 may determine the maximum pixel value pₘₐₓ of the pixels in a first region and the number num of pixels having a pixel value greater than the first preset value, in the background marker image.

If pₘₐₓ is greater than or equal to the second preset value and num is greater than or equal to the preset number, the target may be determined to be a false target. In one embodiment, the first preset value may be smaller than the second preset value.

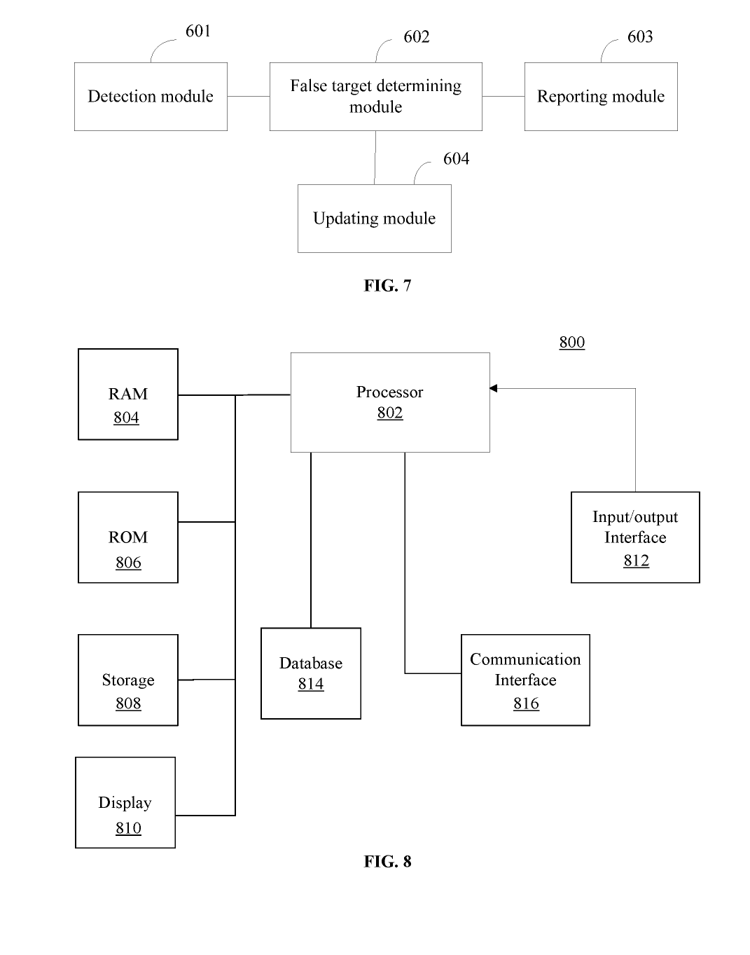

In some embodiments, as shown in FIG. 7, the disclosed device may further include an updating module 604, to update the pixel values of the pixels in the first regions in the background marker image.

In some embodiments, the updating module 604 may also update the pixel values of the pixels in the second regions in the background marker image. A second region may correspond to the area occupied by each one of the N targets in the previous video frame image.

N may be an integer. The N targets may be targets determined when performing a target detection on the previous video frame image. The time interval between the previous video frame image and the currently-to-be-detected video frame image may be a preset time interval.

The disclosed device may be used to execute the technical solutions provided in FIGS. 2, 4, and 5. The principles and technical effect of the disclosed device may be referred to previous description and are not repeated herein.

It should be understood by those skilled in the art that, at least part of the method disclosed in the embodiments may be implemented through computer programs and related hardware. The computer programs may be stored in the readable medium of a computer. When the computer programs are being executed, the steps illustrated in FIGS. 6 and 7 may be executed. The readable medium may include one or more of a read-only memory (ROM), a random access memory (RAM), a disk, a compact disc (CD), and other suitable medium capable of storing computer programs.

FIG. 8 illustrates a block diagram of the controller 800 used in various embodiments of the present disclosure. The controller 800 may include the detection module, the false target determining module, the reporting module, the updating module, and any related software and hardware used in the embodiments of the present disclosure.

The controller 800 may receive, process, and execute commands from the LED lighting device. The controller 800 may include any appropriately configured computer system. As shown in FIG. 6, controller 800 may include a processor 802, a random access memory (RAM) 804, a read-only memory (ROM) 806, a storage 808, a display 810, an input/output interface 812, a database 814; and a communication interface 816. Other components may be added and certain devices may be removed without departing from the principles of the disclosed embodiments.

Processor 802 may include any appropriate type of general purpose microprocessor, digital signal processor or microcontroller, and application specific integrated circuit (ASIC). Processor 802 may execute sequences of computer program instructions to perform various processes associated with controller 800. Computer program instructions may be loaded into RAM 804 for execution by processor 802 from read-only memory 806, or from storage 808. Storage 808 may include any appropriate type of mass storage provided to store any type of information that processor 802 may need to perform the processes. For example, storage 808 may include one or more hard disk devices, optical disk devices, flash disks, or other storage devices to provide storage space.

Display 810 may provide information to a user or users of the controller 800. Display 810 may include any appropriate type of computer display device or electronic device display (e.g., CRT or LCD based devices). Input/output interface 812 may be provided for users to input information into controller 800 or for the users to receive information from controller 800. For example, input/output interface 812 may include any appropriate input device, such as a keyboard, a mouse, an electronic tablet, voice communication devices, touch screens, or any other optical or wireless input devices. Further, input/output interface 812 may receive from and/or send to other external devices.

Further, database 814 may include any type of commercial or customized database, and may also include analysis tools for analyzing the information in the databases. Database 814 may be used for storing related information, e.g., Table 1 and Table 2. Communication interface 816 may provide communication connections such that controller 800 may be accessed remotely and/or communicate with other systems through computer networks or other communication networks via various communication protocols, such as transmission control protocol/internet protocol (TCP/IP), hyper text transfer protocol (HTTP), etc.

In one embodiment, the processor 802 may receive data through the communication interface 816. The data received may include information associate with targets and the background of the targets. The processor 802 may perform certain calculation, according to a desired recognition algorithm to compare the detected objects to the target models, to determine at least one target. The processor 802 may also generate a background marker image to correspond to the background of the targets. The background marker image may reflect the dimensions of the background and the area occupied by each target. The processor 802 may further analyze the pixel values of the pixels in the region occupied by a target and determine if the target is a false target. Details of the process to determine a false target have been described previously and are not repeated herein. The disclosed device may also display the result of the target detection on the display 810.

For illustrate purposes, terms of “first”, “second”, and the like are used to merely distinguish different objects, and do not refer to any differences in function nor imply any order.

Modules and units used in the description of the present disclosure may each contain necessary software and/or hardware components, e.g., circuits, to implement desired functions of the modules.

According to the present disclosure, based on the area of each one of the at least one target in the currently-to-be-detected video frame image, and the background marker image indicating the area occupied by the background of the at least one target, false targets, in the at least one target, may be determined. The non-false targets other than the false targets in the at least one target may be reported. Thus, false targets in the at least one target may be eliminated based on the background marker image. Compared to the technique that uses images of false targets as negative samples to retrain the detection models and eliminate false targets.

Further, based on the pixel value of each pixel in a first region in the background marker image, false targets may be determined among each target, of the at least one target. The pixel value of each pixel in the background marker image may indicate the probability of the pixel being a part of the background. Further, non-false targets other than the false targets, in the at least one target, may be reported, so that false targets in the at least one target may be eliminated based on the background marker image. Compared to the technique that uses false images as negative samples to retrain the detection models and eliminate false targets, detection models may not need to be retrained according to the disclosed method. Accordingly, the cost of post-maintenance of the detection models and instability of the detection models may be reduced.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A method for a target detection, comprising:
performing a target detection on a currently-to-be-detected video frame image to determine at least one target;
based on an area occupied by each of the at least one target in the currently-to-be-detected video frame image and a background marker image, determining false targets present in the at least one target, the background marker image being configured to indicate an area occupied by a background of the at least one target; and
reporting non-false targets other than the false targets in the at least one target.

2. The method according to claim 1, wherein:
a height of the background marker image is same as a height of the currently-to-be-detected video frame image;
a width of the background marker image is same as a width of the currently-to-be-detected video frame image;
a resolution of the background marker image is same as a resolution of the currently-to-be-detected video frame image; and
a pixel value of a pixel in the background marker image is used to indicate a probability of an area corresponding to each pixel being a part of the background.

3. The method according to claim 2, wherein the step of determining false targets present in the at least one target includes:
for each of the at least one target, based on pixel values of pixels in a first region of the background marker image, determining if each target is a false target, the first region of the background marker image corresponding to an area occupied by the target in the currently-to-be-detected video frame image.

4. The method according to claim 3, wherein the step of determining if each target is a false target based on pixel values of pixels in a first region includes:
determining a maximum pixel value in the first region and a number of pixels each having a pixel value greater than a first preset value; and
if the maximum pixel value is greater than or equal to a second preset value and the number of pixels each having the pixel value greater than the first preset value is greater than or equal to a preset number, determining each target is a false target, the first preset value being less than the second preset value.

5. The method according to any of claim 2, after determining if each target is a false target, further including:
updating the pixel values of the pixels in the first region of the background marker image.

6. The method according to claim 5, wherein updating the pixel values of the pixels in the first region further includes increasing the pixel value of a pixel in the first region by a preset value, the preset value being greater than 0.

7. The method according to claim 6, further including:
updating a pixel value of a pixel in a second region in the background marker image, the second region corresponding to an area occupied by each of the N targets in a previous video frame image, wherein N is an integer and the N targets are targets determined through a target detection on the previous video frame image.

8. The method according to claim 7, wherein a time interval between the previous video frame image and the currently-to-be-detected video frame image includes a preset time interval.

9. The method according to claim 7, wherein updating the pixel values of pixels in the second region further includes decreasing the pixel value of a pixel in the first region by the preset value.

10. The method according to claim 1, wherein the at least one target includes a target set.

11. The method according to claim 10, further including:
determining a maximum pixel value and a number of pixels having a pixel value greater than a first preset value for a target in the first region; and
if the maximum pixel value is greater than or equal to a second preset value, and the number of pixels having a pixel value greater than the first preset value is greater than a preset number, determining the target to be a false target.

12. The method according to claim 11, further including:
based on the target set, updating a target queue detected in a preset time interval and the background marker image, wherein the target queue includes a queue of target sets detected in the preset time interval.

13. A device for a target detection, comprising:
a detection module, configured to perform a target detection on a currently-to-be-detected video frame image to determine at least one target;
a false target determining module, configured to determine false targets present in the at least one target based on area occupied by each of the at least one target in the currently-to-be-detected video frame image and a background marker image, the background marker image indicating an area occupied by a background of the at least one target; and
a reporting module, configured to report non-false targets other than the false targets in the at least one target.

14. The device according to claim 13, wherein:
a height of the background marker image is same as a height of the currently-to-be-detected video frame image;
a width of the background marker image is same as a width of the currently-to-be-detected video frame image;
a resolution of the background marker image is same as a resolution of the currently-to-be-detected video frame image; and
a pixel value of a pixel in the background marker image is used to indicate a probability of an area corresponding to each pixel being a part of the background.

15. The device according to claim 14, wherein determining false targets present in the at least one target includes:
for each of the at least one target, based on pixel values of pixels in a first region of the target, determining if each target is a false target, the first region in the background marker image corresponding to an area occupied by the target in the currently-to-be-detected video frame image.

16. The device according to claim 15, wherein:
the false target determining module determines a maximum pixel value of pixels in the first region and a number of pixels having a pixel value greater than the first preset value, in the background marker image; and
if the maximum pixel value is greater than or equal to a second preset value and the number of pixels each having the pixel value greater than the first preset value is greater than or equal to a preset number, the false target determining module determines each target is a false target.

17. The device according to claim 16, wherein the first preset value is less than the second preset value.

18. The device according to claim 14, further including:
an updating module, configured to update pixel values of pixels in the first regions.

19. The device according to claim 18, wherein:
the updating module is configured to update pixel values of pixels in a second region in the background marker image, the second region corresponding to an area occupied by each of N targets in a previous video frame image, N being an integer, the N targets being targets determined through a target detection on the previous video frame image, the time interval between the previous video frame image and the currently-to-be-detected video frame image being a preset time interval.

20. The device according to claim 13, wherein:
the at least one target includes one or more target sets.
